(19) United States
(12) Patent Application Publication
(10) Pub. No.: US 2004/0034537 A1
(43) Pub. Date: Feb. 19, 2004

(54) Guest relationship management system

(75) Inventors: John S. Gengarella, San Jose, CA (US); Mark R. Pawloski, North Lauderdale, FL (US)

Correspondence Address: SUGHRUE MION, PLLC, 2100 PENNSYLVANIA AVENUE, N.W., WASHINGTON, DC, 20037, US

(73) Assignee: PINEAPPLE SYSTEMS, INC.

(21) Appl. No.: 10/218,082

(22) Filed: Aug. 14, 2002

(51) Int. Cl. G06F 17/60

(52) U.S. Cl. 705/1; 705/5

(57) ABSTRACT

A method for implementing a guest profiling program that utilizes guest profiles, which. are developed and expanded by information gathered from various sources and managed in a central Guest Relationship Management System (GRMS). The GRMS is a web-architected internet application. The primary interface between the GRMS and hotel systems is a connection to each hotel's property management system (PMS). The GRMS extracts data from PMSs. PMS data is updated to the central GRMS for processing. The core application logic includes capabilities to identify reservations with attributes and to match guest reservations extracted from each hotel's PMS with profiled guests. Both automated and user-initiated data manipulation processes utilize the central GRMS profiles and PMS data to generate outputs designed to increase the quality and timeliness of services and to assist marketing efforts. The web-based architecture of GRMS enables consistent data sharing and processing capabilities with a plurality of hotels.

### BACKGROUND OF THE INVENTION

1. Technical Field

This invention relates to the field of systems for recording profiles of hotel guests, and in particular, to systems profiling guest preferences, interests, communication and activity across affiliated hotel properties for use in on-property guest recognition and marketing programs.

2. Background Art

Most hotels have attempted an implementation of some form of guest tracking to identify and reward their valuable customers. The depth and breadth of these guest tracking initiatives range from individual hotels storing paper files of hand-written notes on high-volume guests to thousands of affiliated hotels participating in a formal frequent guest program. Guests who register for the frequent guest program are provided with a unique identification number and associated customer account. For guests who supply a frequent guest identification number in their reservation, hotels forward stay data, such as nights stayed in the hotel and total dollars spent, to a central system to credit the guest's account with the appropriate points. These points can be exchanged for products and services as well as hotel accommodations and airline tickets. Guests also are categorized into different tiers as a result of the total points accumulated over a specific period of time. This categorization allows hotels to offer enhanced services or opportunities to guests by tier or status.

Industry consolidation, growth and various ownership and management structures have created challenges in the way in which frequent guest programs have been implemented. Despite the increased number of hotel properties affiliated with a hotel company, conventional hotel management practices continue to regard hotel properties as autonomous, decentralized entities that compete with each other for valuable customers. Customer tracking approaches, if any, vary from one hotel to the next. And few attempts, if any, have been made to coordinate customer information across affiliated hotel properties.

Individual hotels face both operational and technical barriers to coordinating customer profile data for use within each specific hotel as well as across affiliated properties. Hotel properties lack standardization of even the most basic systems. Guest data accumulated by different systems even within the same hotel are very often in different and incompatible formats. There is no ready means to consolidate this data or make it easily available for use at other hotels.

The hotel industry, among many others, desires to achieve a high level of guest satisfaction. It is proposed that one critical element in enhancing guest satisfaction is delivering personalized service. To accomplish this, it is highly desirable to keep extensive records of guests' personal information, preferences, interests, communication history and stay history within related hotels. It is also desirable to provide guests with access to their individual profiles for review and modification. It is desirable to make guest profile information available to authorized hotel staff for review and analysis and also to append guest profiles with newly acquired information. It is further desirable to make such information available to hotels that are related to each other, for example, a chain of hotels, regardless of what hotel(s) within the chain the guest has stayed in the past. It is also desirable to enable hotels to communicate consistently with their guests in a systematic manner before, during and after each hotel visit. It is further desirable to have an automated system capable of identifying profiled guests and manipulating reservation and associated guest profile information to produce and distribute a useful output to enable on-property fulfillment of guest preferences and the delivery of personalized services. Additionally, it would be further desirable to provide controlled access from both the individual hotels and the corporate hotel groups to utilize hotel-specific and aggregate guest profile data for analysis and direct marketing efforts. However, there are no systems that are capable of performing these functions.

There are known systems that store guest data. However, there are problems and disadvantages with such systems. For example, one problem is that the current approach and technology employed by hotel companies fails to create a capability for consistent and extended guest recognition. Since there is no technology automatically to identify repeat or frequent guests, hotel companies access from the chain's central reservations system (CRS) guest reservations which have a frequent guest number or an airline mileage program number. This approach limits the target audience for guest recognition to program participants who have successfully provided an accurate identification number at the time of reservation. More important, since hotel companies access guest reservations at the CRS instead of from the individual property management systems (PMS) at each hotel, there is no capability to identify the status of any given reservation (cancelled, no-show, in-house, checked-out) at any point throughout the guest's planned stay other than a scheduled arrival on or before the day of arrival. This approach limits the ability to recognize and service a targeted guest throughout the course of a multi-day stay.

A second problem with current systems is their inability to allow a multiplicity of hotels in geographically dispersed locations to share guest information. One hotel within a chain may have recorded details of a guest's preferences, interests and history but, with the current systems, neither the central reservations system nor any other affiliated hotel's property management system can access this guest data.

A third problem with existing systems is an inability of hotel properties or hotel groups to consolidate guest data to provide a complete view of the guest and to allow guest information to be easily accessed, manipulated and modified. Hotels and corporate hotel organizations collect and store guest data within a variety of disparate systems such as the reservation system, property management system, point of sale systems, frequent guest system, accounting systems, concierge systems, comment card systems and task management systems. The inability to consolidate guest data and the lack of local access to guest data prevents hotels and hotel companies from serving specific guests with a current awareness of the guest's stay history, spending, interests, complaints and other relevant information.

A fourth problem with the existing systems is that the amount and type of information that may be transferred between systems is limited. A hotel group's central reservations system (CRS) transfers reservations to each specific hotel's property management system (PMS). Because one chain of hotels may support a variety of different property management systems, each with limitations on available fields in which to record guest data, the transfer of information between the CRS and the PMSs is limited to the basic reservation data, such as the guest's name, arrival and departure dates, and a limited set of two-letter guest preference codes such as “NS” to denote a request for a non-smoking room.

A fifth problem with the existing hotel systems is the absence of a programmable fulfillment system capable of automated on-property distribution of guest information. There is no capability within either a hotel's property management system or a system working in conjunction with the PMS to program events to systematically support various guest preference fulfillment scenarios. It is not currently possible to program the PMS to identify the next arrival or a specific arrival of a specific guest and, following the identification of a targeted guest, produce and distribute output for various hotel operations teams depending on the attributes defined in the guest's reservation and the corresponding guest's profile and also depending on the service standards defined by each individual hotel. Additionally, there exists no capability within the current systems to produce and distribute such output throughout the entire lifecycle of a guest's hotel experience including pre-arrival, at check-in, while the guest is in the hotel, at check-out and post check-out.

A sixth problem with the existing hotel systems and methodologies is the limited scope of guest profiles and profiling activity. Hotel companies create limited profiles (for example, contact information, preferences for bed type, room type, floor preference, pillow type) of guests who voluntarily join the chain's frequent guest program. The current definition of a guest profile limits the opportunity to develop an in depth understanding of the guests, their activity, interests and value as it has a limited scope and fails to integrate with other systems which record guest information. Also, since profiles are only created for guests who voluntarily join the hotel's frequent guest program, hotels and hotel companies fail to address the majority of their guests, many of whom may be significant contributors to an individual hotel and to the chain.

A seventh problem with the current systems is the inability of hotels to maintain and manage a dialogue with guests throughout the lifecycle of a guest's hotel experience, from the reservation to after the guest has checked out. There are no systems in place to manage the information exchange between the hotel and the guest to enhance the guest experience, reduce the likelihood of service errors and capitalize on marketing opportunities. Today, guests make reservations by providing the standard information consistent with the fields of a central reservation system. Hotels, at best, provide a mailed or emailed confirmation letter with a textual replica of the reservation information. There are no systems designed to systematically communicate with the guest utilizing individualized guest information from the guest's profile at each stage of the guest's stay experience; before arrival, at check-in, while in the hotel, at check-out and after check-out.

An eighth problem with the current systems is that there exists no capability for individual hotels to initiate and manage marketing campaigns utilizing guest profile data from guests who have visited their individual hotels. Campaign management applications, at best, are deployed by the corporate hotel organizations utilizing limited guest profile data. Individual hotels do not have access to an application which would allow them to analyze guest profiles, their respective activities and contributions and then to mange a marketing campaign directed at targeted guests based on specific criteria.

An additional problem with the current systems is that guests have limited, if any, access to review or modify their own personal profile information or to exchange data with the hotel or the hotel company. Current systems have, at best, access to a standard guest profile with limited attributes in which to submit guest information. There exists no capability to submit non-standard preferences or to customize the delivery requirements to meet specific guest-defined rules. Additionally, there is no capability to interface with the hotel or hotel company to exchange information such as downloading folios, submitting on-line guest comment cards or requesting to be notified for specific offers or events consistent with defined guest profile attributes.

Yet another problem is the limitations imposed by the architecture of the existing systems. Property management systems are local applications designed for a local network with a client-server architecture. Each hotel must install and support various models and versions of a property management system. Hotel chains face limitations because their hotels do not utilize one single standard PMS. A web-based architecture consisting of an application service provider (ASP) provides the benefit of an ASP model having one central application accessed by an entire chain of hotels.

### SUMMARY OF THE INVENTION

The present invention is a system and method for implementing a web-architected guest relationship management system (GRMS) that enables affiliated hotels to develop and share guest profiles, automatically distribute information within each hotel to support the delivery of personalized services, and manage personalized marketing and communications between hotels and guests. Guest profiles are developed from information contributed by guests, observed by hotel staff, extracted from hotel systems, and appended as a result of guest activity. Guest profiles are stored centrally and provide affiliated hotels controlled access as necessary to support on-property guest recognition across all properties. The present invention enables segmentation of profiles specific to individual affiliated hotels as well as controlled access to applications utilizing aggregate profile data.

In the preferred embodiment of the invention, the guest relationship management system provides a web-based central application which allows authorized users such as guests, local hotel staffs and corporate hotel personnel to interact with an application that supports the development and distribution of guest profiles throughout a network of affiliated hotels. The GRMS interfaces with local hotel systems and corporate hotel systems to access and share guest data. An objective of the application is to develop extensive guest profiles through information offered directly by the guest, from knowledge acquired about the guest by hotel and corporate staffs and through systems which record the guest activities.

The core capability of the application is its ability to identify profiled and targeted guests across a collection of affiliated hotels and throughout the lifecycle of their hotel stay experience (pre-arrival, check-in, in-house, check-out, post check-out) and automatically to distribute information to the guest and the hotel service teams to enable the delivery of a customized and personalized stay experience. Guest identification is accomplished by the GRMS application comparing guest information from each hotel's property management system to the central database of guest profiles. The comparison technology produces exact matches and potential guest matches with the corresponding probability. Because the GRMS interfaces with each hotel's PMS, the GRMS can monitor guest status and status changes such as a “scheduled arrival” to a “cancellation” or an “in-house” status to a “checked-out” status. Integrated within the guest identification capability is the ability to utilize PMS reservation data, the corresponding guest profile data and the business rules defined by the individual hotel and corporate hotel group to generate and distribute output directed at the guest and the service teams to enable personalized servicing of each identified guest consistent with the guest's profile and historical contributions and activity. This automated guest profile fulfillment methodology and technology produces output which defines the responsible individual or team, the necessary actions to be taken and the timing of the service delivery.

As developing extensive guest profiles is the core objective of the GRMS, the application provides several manners in which stored guest profiles can be updated, edited, or manipulated by the hotel staff, by the corporate staff, by the import of new or updated data from hotel or corporate systems, by the GRMS itself, and by the guest. Additionally, the GRMS provides the capability to manage the solicitation of targeted guests. The GRMS also provides the capability to develop guest profiles using available data from local and corporate systems and staff without the active participation of the guests.

To capitalize on the development of extensive guest profiles, the GRMS provides a suite of analysis, communication and marketing tools. The GRMS provides the local hotels and corporate hotel groups the capability to access and manipulate the central GRMS database of guest profiles to analyze guest activity, trends, contributions, communications and requests. The GRMS communication module systematically produces personalized communications with targeted guests utilizing information from the guest's reservation and profile at each stage of the guest's stay experience; before arrival, at check-in, while in the hotel, at check-out and after check-out. Additionally, the GRMS provides a campaign management tool to support targeted direct marketing utilizing individual guest profile data.

### BRIEF DESCRIPTION OF THE DRAWINGS

The above objects and advantages of the present invention will become more apparent by describing in detail preferred embodiments thereof with reference to the attached drawings in which:

FIG. 1 is a diagram of a guest relationship management system (“GRMS”) according to a preferred embodiment of the present invention;

FIG. 2 is a flowchart of an import process for use in the GRMS of FIG. 1;

FIG. 3 is a diagram of a profile location process for use in the GRMS of FIG. 1;

FIG. 4 is a diagram of a profile creation process for use in the GRMS of FIG. 1;

FIG. 5 is a diagram of a dating mining process for use in the GRMS of FIG. 1;

FIG. 6 is a diagram of a campaign manager process for use in the GRMS of FIG. 1;

FIG. 7 is a diagram of a service sequence table for use in the GRMS of FIG. 1;

### DETAILED DESCRIPTION OF PREFERRED EMBODIMENTS OF THE INVENTION

A preferred embodiment of the present invention is described below in detail with reference to the accompanying figures. The present invention is described herein by way of example and is not intended to be limited to the described embodiment.

The present invention relates to a web-enabled Guest Relationship Management System (“GRMS”) for the hospitality industry, and includes an enterprise software solution that enables individual hotels and affiliated hotels to create, distribute, share and analyze the personal profiles, preferences, interests, stay history and communication history of targeted guests. A goal of the solution is to create a personal relationship with targeted guests and to deliver customized accommodations and personalized service consistent with the guest's profile, defined preferences, interests and activity.

The solution enables hotels to achieve, by way of example, the following objectives:

manage membership solicitation,

manage guest communication throughout the lifecycle of a guest experience,

record and access extensive member profiles,

automatically identify arriving guests within each hotel who match the hotel-defined selection criteria,

automatically identify arriving and in-house guests within each hotel for whom member profiles have been created,

automatically distribute member information to specific service teams throughout the hotels at specific times to enable the delivery of personalized service,

share access to member profiles with geographically dispersed hotels,

manipulate aggregate profile data for analysis, reporting and marketing,

manage communications and marketing campaigns directed at selected members,

solicit, record, respond and reply to guest comments, complaints and surveys,

receive, respond and reply to special guest requests,

confirm reservations in advance of guest arrivals, and

push requested GRMS data to hotel systems and complementary applications and exchange relevant guest data.

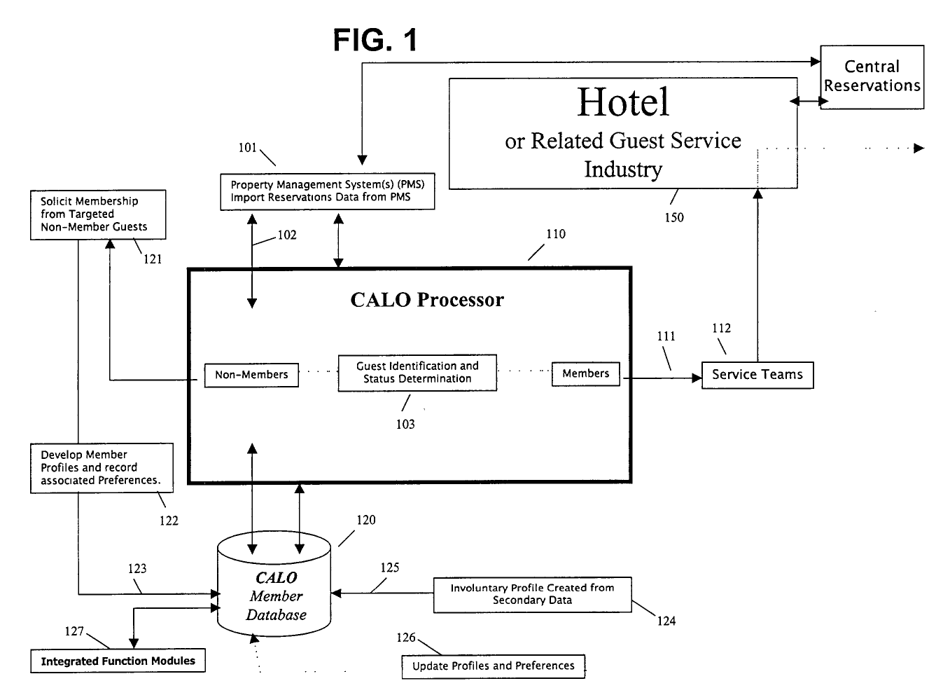

FIG. 1 illustrates a preferred embodiment of the web-enabled Guest Relationship Management System (“GRMS”) according to the present invention.

With reference to FIG. 1, GRMS is generally composed of: one or more hotel property management systems (“PMS”) (101); a data importation method transferring initial imported data (102); the overall GRMS processing functions (110) which comprises the identification of guests by matching profiles and further comparing a hotel guest list with the CALO database (120) for member identification (103), the generation of lists of arriving and in-house members and further the creation of reports using member profile and preference information; the delivering of the reports (111) to various hotel service teams (112) and the utilization of the reports by service teams (112) to deliver specialized service or accommodations; and a hotel or similar facility where like services are rendered. (150)

The generated member reports include but are not limited to: service team performance reports, preference confirmation, welcome cards, VIP or special occasions, Bellmen cheat sheets, daily removal reports and member history reports as well as any other report generated to improve services and guest accommodations. The service teams (112) that may use these generated reports include but are not limited to: room service, house keeping, maintenance, teams that generate welcome cards or VIP reports, teams that generate special occasion reports, and finally, food preparation and service teams.

With reference to FIG. 1, GRMS is further composed of: the solicitation of non-member guests to become members (121); the development of member profiles and preferences (122) as a result of such solicitation (121) and other means; the importation of member profiles, preferences and other information (123) into the CALO Database (120); the collection of secondary data from means such as comments, surveys, complaints and strategic hotel targets to create an involuntary user profile (124); transmission and importation of involuntary user profile information (125) into the CALO Database (120); updating member profiles and preferences based upon information gathered during member's stay (126); and further utilizing integrated function modules (127) such as: query builders, campaign managers, guest communications systems, guest recovery systems and task management systems to allow updating of member profiles or preferences and the manipulation of data into and out of the CALO Database. (110, 120)

The GRMS is a centrally located hosted software application which imports data that has been extracted from various geographically dispersed hotel property management systems (PMS). (101) The GRMS imports data from participating hotels via an agent (for example, a Java applet residing on a device which interfaces with the PMS) (102) that imports a table/CSV/XML catalog of data, stripes it into a new markup language and then delivers it to the server repository via an internet connection, or other similar data transfer means, where it is processed by the GRMS. (110) The GRMS provides for the participating hotels web-enabled access to a centralized Guest Relationship Management System and a shared central database. Throughout the specification, web-enabled access is not limited to traditional internet access but may also include extranet connections, direct connections and other means readily understandable to one skilled in the art.

The invention includes an enterprise encompassing, scalable web-based solution made up of several components based on an application service provider (ASP) architecture. The invention includes an independent application residing outside of the current hotel and hotel company systems with a design which allows a successful interface with or data extraction from various property management systems.

A system in accordance with the present invention comprises a web-based enterprise software application made up of several components based on an application service provider (ASP) architecture. Authorized individuals access the central GRMS application via standard internet browsers on web-enabled devices such as personal computers. Each individual hotel hosts an agent which interfaces directly with the hotel's property management system (PMS) (101) to feed both batch and real-time PMS and other pertinent hotel site data to the central guest relationship management system over a secure Internet channel. All interfaces are web-based, standardized, centrally upgradeable and accessible over a secured extranet to authenticated users. The central GRMS is designed on scalable enterprise database, within a load balancing and a data warehousing environment and multitasking part transactional and part data mining schema designs. In the preferred embodiment, the application is designed in an industry standard XML architecture and data model which enables migration to all standard enterprise platforms, database solutions and operating systems (Solaris, HPUX, Linux and Windows 2000). The application logic and business rules are programmed in a Java supported application based on an XML smart-tag execution engine. All application logic is modularized into components which operate independently of one another and can be assembled to provide the best dynamic solution to a particular site or group of sites.

According to the preferred embodiment, the connection is via the internet; however, as is well known to those of ordinary skill in the art, there are many other viable means of connecting the various chains to one another. The term “connection” does not necessarily mean physically connected, but may also include connections via wireless technology as an example. Although the preferred embodiment is described with respect to a chain of hotels, the present invention is not so limited and may easily be adapted to other businesses having multiple geographically dispersed offices and to other applications.

When a guest has contact with a hotel, an employee of the hotel will enter substantive content of the guest communications into the hotel's PMS. (101) Guest information may also be entered into the PMS automatically, for example, by guest contact with a hotel's website or from direct connections at a hotel. (127) Such communications could include, among other things, making, canceling, or changing a reservation or making other special requests. Guests may communicate with the hotel in a wide variety of ways, including use of electronic communications such as telephone, e-mail and facsimile, mail-in response cards, and by use of the hotel's web site. Additionally, hotel staff may edit the reservation and guest information as needed without receiving a communication from the guest.

These entries into the PMSs result in a quantity of new PMS reservation data. On a regular interval, the GRMS imports, via the internet connection, the new PMS reservation data entered into the PMS. This new PMS reservation data undergoes several analytical steps, as described below, before eventually being appropriately stored in the GRMS and made available for future use.

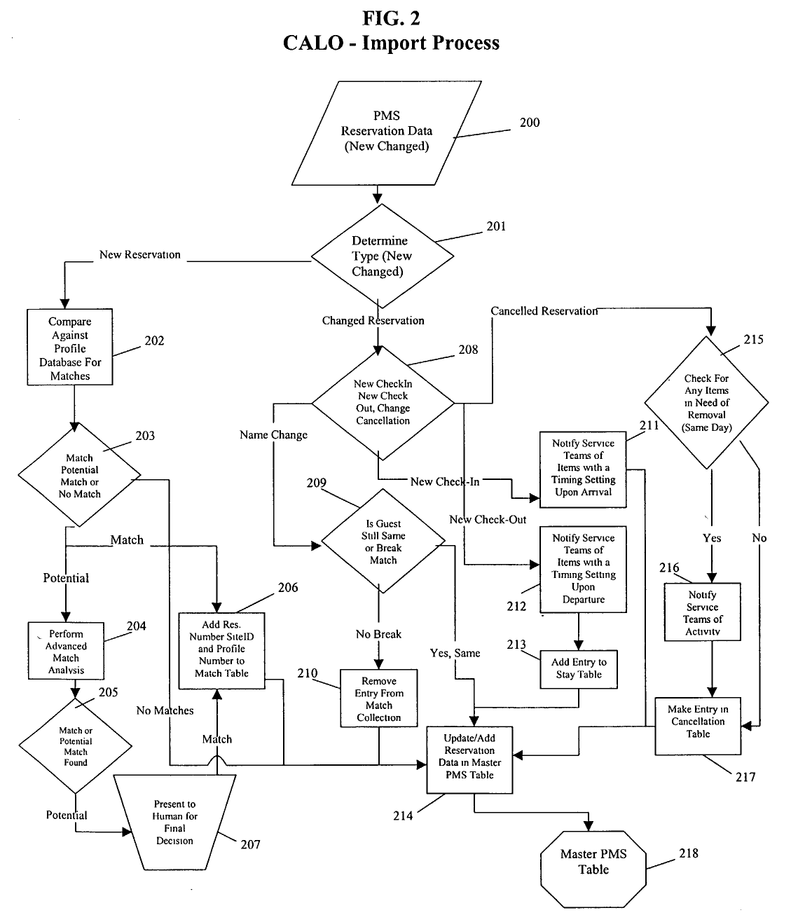

FIG. 2 is a flowchart of the import and match process carried out by the GRMS. This process extracts reservation information from the hotel's PMS and compares it to the central database of member profiles to identify reservations that may have a corresponding profile. The end result of this process is a Match Table that includes the hotel's Site ID, the unique Reservation Number from the PMS, and unique Profile IDs that are exact matches with guest reservation information. Potential matches are addressed during the process and are held in a Potential Match Table until verified and transferred to the Match Table or dismissed. Reservations, profile information and service sequence matrix data provide the data sources for report generation. Additionally, all reservation data is stored for future comparison to updated reservation data to identify new, updated or deleted reservations or reservations with changed status.

In addition to a comparison of PMS data and the central database of member profiles, the match process also identifies PMS data which meet hotel-specified criteria. Hotels may target specific individuals at the individual hotels and the hotel companies may attempt a brand-wide recognition of specific individuals. For example, hotels or hotel groups may wish to identify guests which do not have guest profiles, but who have one or more of the following characteristics in their reservation:

A frequent guest number

An airline mileage number

A history of a prior stay in a specific hotel as determined by a comparison of guest history data

A designation as an employee of a specific targeted company

A guest reserving a room at or above a specific rate

A guest with a specific stay pattern

A guest reserving a specific room type

While these guests may not have matching member profiles, they may be targeted by the hotel or the hotel group for membership solicitation and special services.

Because multiple sites may be processing potentially hundreds of reservations per day against the central database (of potentially millions of profiles), the processing preferably is a regularly scheduled event. This process is automatic, and only if Potential Matches are identified and in need of user intervention does this process require user interaction.

On regularly scheduled intervals, the system imports guest reservation, folio and history data from the hotel's PMS to identify new reservations and reservations for which the status has changed. New and changed reservations are determined by a comparison of the most recent import to the prior import of reservation data. Reservations with identical Reservation Numbers accept the Status of the current import data. Reservation numbers with an In-House status which do not exist in the current import are recorded as Checked Out. Reservation numbers with an Arriving status which do not exist in the current import are recorded as Cancelled. This process enables the availability of current reservation data for processing and recording guest reservation activity.

Cancelled reservations are recorded in the member profile if a member profile is determined to exist following the comparison process. All reservations with a Checked-Out status are recorded in a Stay History Table and reservations with a corresponding member profile record the Member Profile ID in its Stay History Record.

The import window, for one embodiment, includes seven (7) days of reservations; three days of history, the current day, and the next three days of reservations. This process imports at least some of the following data from the PMS for each reservation (unique identifiers are bolded):

Reservation Number (unique number within the PMS for each reservation)

PMS Guest ID Number (attempting to provide a unique ID for each guest within the local PMS)

Title (Mr., Mrs., . . . )

Name (LastName, FirstName)

Arrival Date

Departure Date

Booked Date (for Days Booked in Advance of Arrival)

Booked Source (GDS, Central Reservations, Online, Property)

Company Name

Address1

Address2

City

State

Postal Code

Phone Number

Email Address

Status of Reservation (Confirmed, In-House, Cancelled, Out)

Room Rate ($)

Charges (total charges posted to that folio at checkout)

Room

F&B

Phone

Parking

Movies

Other

Market Segment (specific codes for each market segment)

Group Code (specific group booking)

Package (Getaway Weekend)

Plan Code (BB, Gov, . . . )

Corporate ID Number

Room Number

Expected Check-in Time

Check-In Time

Expected Check-out Time

Check-Out Time

Credit Card Type

Credit Card Number

Credit Card Expiration

Frequent Flyer Type

Frequent Flyer Number

Frequent Guest Type (Silver, Gold, Platinum)

Frequent Guest Number

Frequent Car Rental Type

Frequent Car Rental Number

Messages (may be 0 to n lines of messages from Message Table in PMS)

Notes (may be 0 to n lines of notes from Notes Table in PMS)

Special Service Codes (1 or 2 letter codes to parse and map to special service requests)

Cancellation Information (Date of cancellation for future analysis)

With specific reference to FIG. 2, the GRMS receives PMS reservation data (200), and determines if the recently imported PMS reservation data has been entered into the system as a result of a new reservation or if it has been entered as a result of a changed reservation. (201) This determination is made by comparing the reservation numbers of the newly imported data with the reservation numbers previously stored in the GRMS or through comparison with another reservation unique identifier.

If the process (200, 201) determines the reservation is a new reservation, the GRMS will then compare the PMS reservation data against existing member profiles to determine if the reservation has been made by a guest with an existing member profile. (202) A match, potential match or no match will be determined. (203)

Comparison is based upon the following criteria:

A+B=C

| Abbreviated Name | Unique IDs | Match Status (Yes/Potential/No) |
|---|---|---|
| Yes | At Least One | Yes |
| Yes | No | Potential |
| No | At Least One | Potential |
| No | No | No |

A match will be declared, for example, when the abbreviated member name and at least one of unique identifiers of the newly imported data is identical to the same distinguishing information in an existing profile. (203) These unique identifiers are (as an example) the guest's PMS Guest Identification Number, Frequent Guest Number, Credit Card Number(s), Frequent Flyer Number(s), Frequent Car Number(s), and E-mail address(es). The abbreviated member name is, for example, the first letter of the guest's first name and at least the first four letters of the last name, or the entire last name if the last name is less than four letters. If the last name is more than four letters, then the abbreviated name is the first letter of the first name and the first eighty percent (80%) of the letters of the last name.

A potential match will be declared if the abbreviated member name or at least one of the unique identifiers is identical to the same distinguishing information in an existing profile. (203) If neither the abbreviated name nor any of the six unique identifiers matches, it is determined that there is no match. (203)

If a match is declared, the GRMS will add the reservation number, site ID and profile number to a match table. (206)

If a potential match is declared, the GRMS will perform an advanced match analysis, searching for a solid match. (204) In this analysis, the GRMS will compare additional identifying attributes of the newly imported data (e.g., one or more of Company Name, Address, City, State, Postal Code, Phone Number, Market Segment, Group Code, Package, Plan Code, Corporate ID Number) with the corresponding information in member profiles that are declared potential matches. (205) Based on this comparison, the GRMS will generate a percentage likelihood that the potential match is in fact an actual match.

At this point, the GRMS presents two options. First, the user can set a threshold percentage likelihood for an actual match to be declared. For example, the user can set a 90% threshold value and all potential matches with a percentage likelihood of at least 90% will be declared an actual match. A second option is for the GRMS to present the potential matches to the user to allow the user to make a conclusive determination. (207) For example, if three potential matches are found, these three profiles and the newly imported reservation data are presented to the user. The user can then declare a match or no match based on independent and flexible criteria.

If a potential match is declared an actual match, the reservation number, site ID and profile number will be added to the match table. (206)

If no match is found or a potential match is declared no match, the GRMS will use the PMS reservation data to create a new profile as described below.

If the process (201) determines the reservation is a changed reservation, the GRMS will then determine what type of change has been made. The GRMS will determine if the change is a new check-in, a new check-out, a name change, or a cancellation. (208)

If there is a name change, the GRMS will determine if the guest is still the same or if the change has resulted in breaking the profile match. (209) If there is no break, the GRMS removes the entry from the match collection (210) and will then update and add the reservation data to the master PMS table. (214) If the guest is the same, then the process updates and adds reservation data in the master PMS table. (214)

If the change is a new check-out, the GRMS will notify service teams of items with a timing setting of “Upon Departure”. (212) The GRMS will add the check-out entry to the stay table (213), and then update and add the reservation data to the Master PMS table. (214)

If the change is a new check-in, the GRMS will notify service teams of items with a setting set “Upon Arrival”. (211) The GRMS will then update and add the reservation data to the master PMS table. (214)

If the change is a cancelled reservation, the GRMS will first check for any items in need of removal. (215) If there are no such items, the GRMS will make the entry in the cancellation table (217) and then update and add this information to the master PMS table. If there are items in need or same-day removal, the GRMS will notify the appropriate service team. (216) The GRMS will then proceed to enter the cancellation in the cancellation table (217) and update and add this information to the master PMS table. (214)

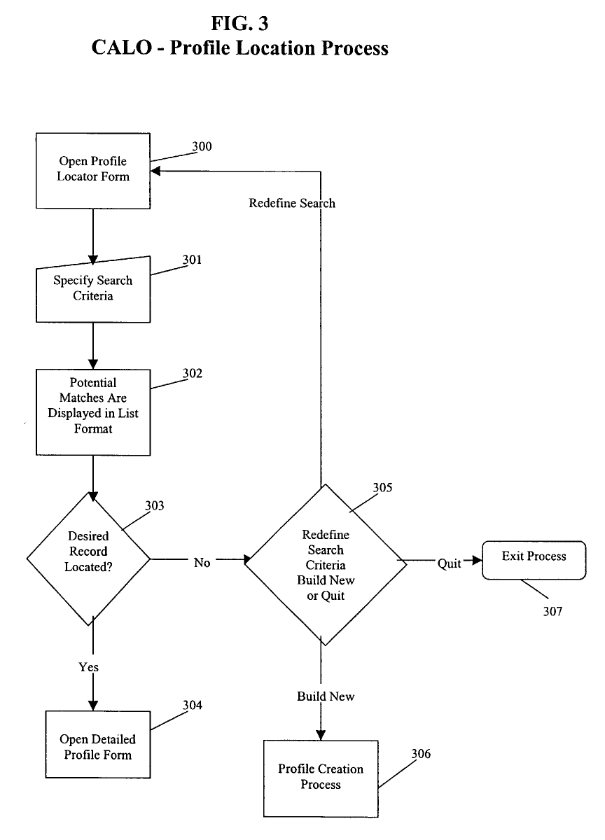

The GRMS also allows for individual profiles to be searched, selected, and viewed. FIG. 3 shows a flowchart illustrating a profile location process. To accomplish this profile location process, the user opens a profile locator form, which is part of the GRMS. (300) The profile locator form allows a user to input search criteria. (301) Following entry of search criteria, the GRMS will search the master PMS table for profiles that match the search criteria. (302) If the search results in the user locating the desired profile (303), the profile can then be opened and viewed. (304) If the desired profile is not found, the user can choose to redefine the search criteria, choose to create a new profile, or quit the search process entirely. (305, 306, 307)

The GRMS also allows for the creation of new profiles. Guest profiles generally include, by way of example, the following components:

1) Contact Information, including home and business addresses and phone numbers and email addresses;

2) Family Information, including family members, relationships, ages, important dates;

3) Travel Information, including frequent guest numbers, frequent airline numbers, frequent car numbers;

4) Credit Card Information, including credit card type, number and expiration date;

5) Preferences for Accommodations and Services, including room type, bed type, location, smoking preference, in-room amenities, services;

6) Interests, including personal interests for both business and leisure activities;

7) Notes, including recorded notes contributed by hotel staff;

8) Stay History, including record of prior stays for specific and all associated hotels; folio information is recorded including charges for room, food and beverage, phone, parking, movies and other; and

9) Communication History, including history of communication with the specific guest via interactions from reservation confirmation emails, guest comments, surveys, complaints and campaign management information.

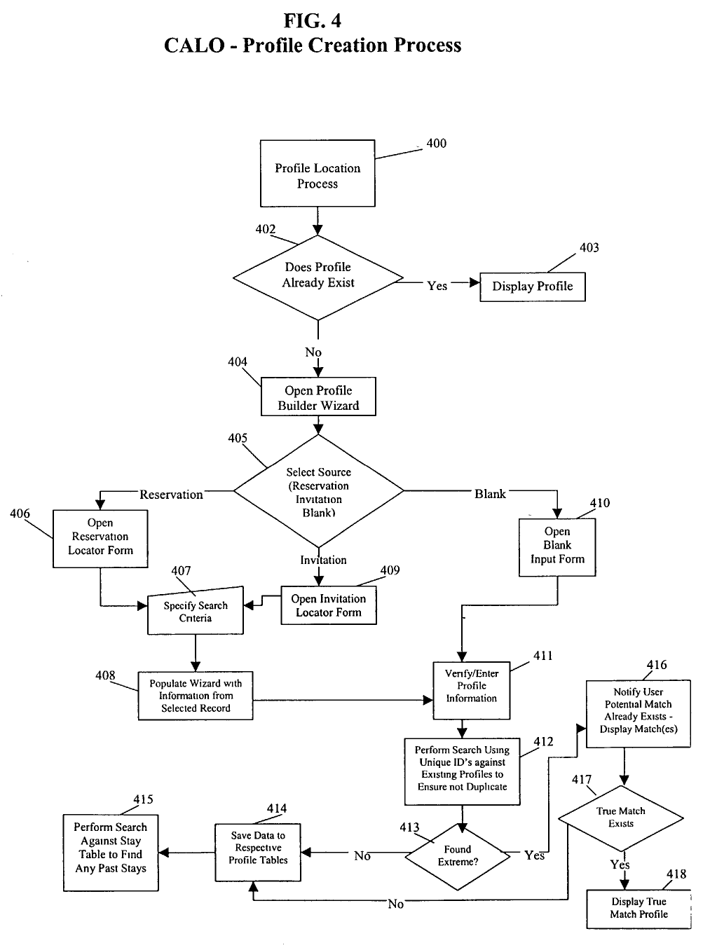

FIG. 4 is a flowchart of a profile creation process of the present invention. (400) The profile creation process allows for new profiles to be created. First, the process checks to see if the profile already exist. (402) This aids in preventing duplicate profiles being created. If the profile exist, it is then displayed. (403) If not, a profile builder is opened. (404) The source of information upon which the new profile is based is then chosen. (405)

If the source is a reservation, a reservation locator form is opened. (406) Then, the user specifies search criteria. (407) The profile builder is then populated with information from the selected reservation record. (408) The new profile is then verified by the user. (411) At this time, additional information can be added or incorrect information can be changed. The GRMS then compares the newly created profile against existing profiles using the profiles unique identifiers to ensure the newly created profile is not duplicative of existing profiles. (413) If no match is found, the profile is then saved to the appropriate profile tables. (414) Following this step, the GRMS searches the stay table to determine if any past stays are associated with the newly created profile. (415) On the other hand, if a potentially duplicative profile exists, those profiles are presented to the user for the user to determine if a true match exists. (416, 417) If the user overrides, the data is saved and a past stay search is performed. (414) If it is determined that a true match exists, the user can select the existing profile. (418)

If the source is a reservation, a reservation locator form is opened. (406) Then, the user specifies search criteria. (407) The profile builder is then populated with information from the selected reservation record. (408) The new profile is then verified by the user. (411) At this time, additional information can be added or incorrect information can be changed. The GRMS then compares the newly created profile against existing profiles using the profiles unique identifiers to ensure the newly created profile is not duplicative of existing profiles. (413) If no match is found, the profile is then saved to the appropriate profile tables. (414) Following this step, the GRMS searches the stay table to determine if any past stays are associated with the newly created profile. (415) On the other hand, if a potentially duplicative profile exists, those profiles are presented to the user for the user to determine if a true match exists. (416, 417) If the user overrides, the data is saved and a past stay search is performed. (414) If it is determined that a true match exists, the user can select the existing profile. (418)

If the source is a reservation, a reservation locator form is opened. (406) Then, the user specifies search criteria. (407) The profile builder is then populated with information from the selected reservation record. (408) The new profile is then verified by the user. (411) At this time, additional information can be added or incorrect information can be changed. The GRMS then compares the newly created profile against existing profiles using the profiles unique identifiers to ensure the newly created profile is not duplicative of existing profiles. (413) If no match is found, the profile is then saved to the appropriate profile tables. (414) Following this step, the GRMS searches the stay table to determine if any past stays are associated with the newly created profile. (415) On the other hand, if a potentially duplicative profile exists, those profiles are presented to the user for the user to determine if a true match exists. (416, 417) If the user overrides, the data is saved and a past stay search is performed. (414) If it is determined that a true match exists, the user can select the existing profile. (418)

For each reservation imported from a hotel's PMS with a status of “Arriving” or “In-House,” the GRMS compares an abbreviated form of the guest's name and the unique identifiers from each reservation with existing member profiles.

Any unmatched reservation and guest information is assigned a PMS Guest Identification Number and a member profile is created. The information is then made available for solicitation. Each PMS Guest Identification Number is compared against a second master table containing prior unmatched PMS Guest Identification Numbers to determine the solicitation history of that specific PMS Guest Identification Number. Each user may define the business rules to determine the frequency of guest solicitations.

The GRMS also manages the guest solicitation process. The GRMS allows a user selectively to solicit:

1) guests with profile information that does not match an existing profile;

2) guests who meet user-selected criteria; and

3) manually-selected guests from a list of available guests.

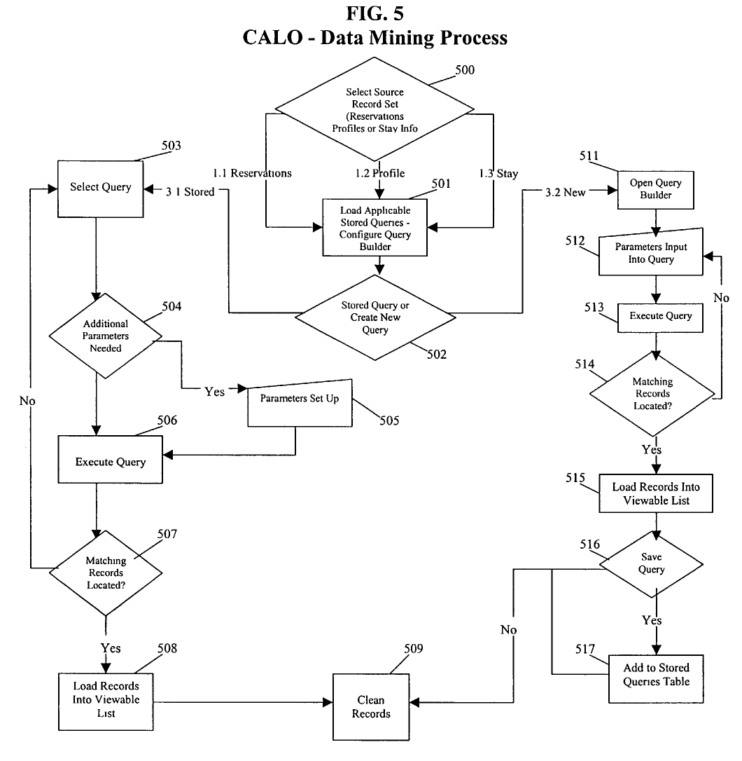

FIG. 5 illustrates a flow chart of the data mining process. Initially, a source record set is selected. (500) This may include reservations, profiles, or stay information. Depending on the type of source selected, the applicable stored query is loaded and configured. (501). Next, a determination is made as to whether to use a stored query or create a new query. (502). If a stored query is desired to be used, it is selected (503), and additional parameters may be added to that query if desired. (504), (505) The query is then executed. (506) All records matching the executed query are located (507) and the matched records are loaded into a viewable list. (508) If no matching records are located in step (507), the process returns to step (503) to select another query or to revise the query. Following step (508), the records are cleaned in (509).

On the other hand, if a new query is desired to be built, then the open query builder is loaded. (511) The parameters are input into the query. (512) The new query is executed in step (513) and all matching records are located in step (514). The matched records located are then loaded into a viewable list. (515) If no matching records are located, then the process returns to step (512) to revise parameters of the query. Otherwise, the user is prompted to save the query (516), and depending on the input the query is stored in a query's table (517) or the records are cleaned in step (509).

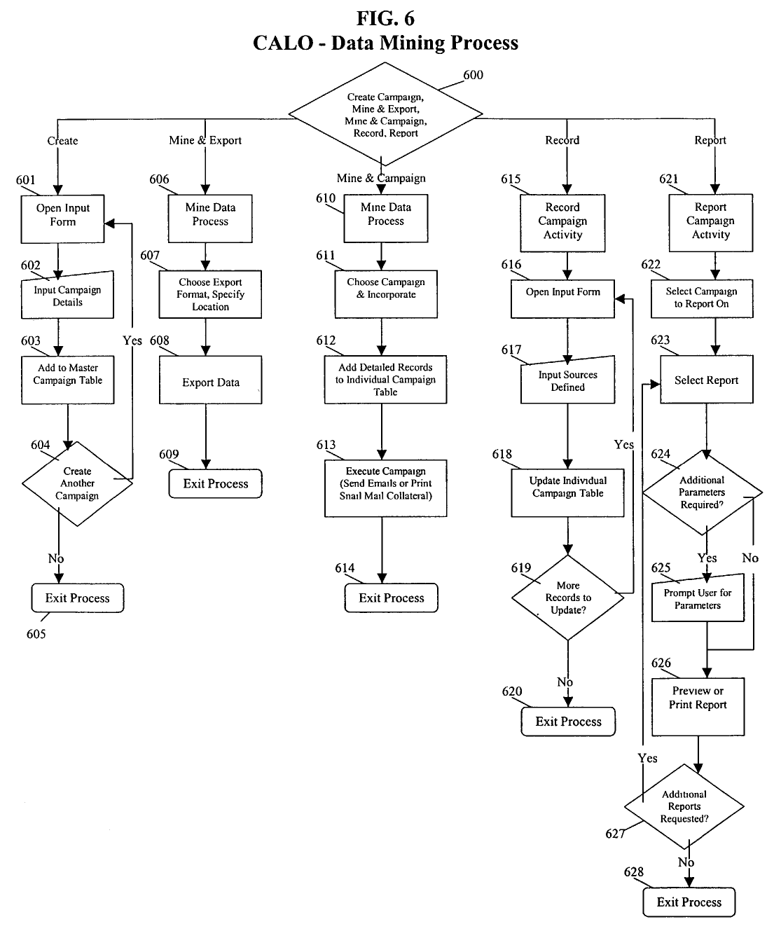

FIG. 6 illustrates a flowchart of the solicitation and campaign management options. The campaign manager provides a comprehensive tool to mine the data base (i.e., profile information, stay history, and reservation records as examples) and export the data to a number of standard formats or use those records as a source for a structured campaign. A campaign is a defined promotion or correspondence applied to a specific set of guests (either with or without profiles). Campaigns track all individuals and their individual activity associated with that campaign, the results of the campaign's efforts and associated cost/performance analysis. The campaigns are organized, fully traceable, and reportable.

As a result, the campaign manager provides a data file in any number of standard formats that can be imported by other applications (e.g., Microsoft Word) to generate merge documents, mailing labels, spreadsheets or campaign collateral. This feature includes all features of the existing mail merge wizard, the query builder and the campaign manager. There are five main processes that appear on the opening page of the wizard. They are:

1. Create a new campaign;

2. Perform data analytics and export the results;

3. Perform data analytics and incorporate the results into an existing campaign;

4. Record the results of a campaign; and

5. Report the results of a campaign.

Referring now to FIG. 6, the campaign manager process is illustrated. (600) A first option allows the user to create campaigns. To accomplish this, a user opens an input form. (601) Then, the user inputs details of the campaign they wish to create. (602) The campaign details are stored to a master campaign table. (603) The process then prompts the user to create another campaign. (604) The process either repeats, beginning at step (601) or quits (605). A campaign may store the following information:

Campaign Name,

Campaign Code,

Date Created,

Date Executed (Mailed, Emailed, Handed out to In-House Guests)

Method Executed (Email, Regular Mail, Hand Outs, etc.),

Applicable Dates of Campaign (Offer valid Apr. 1, 2001-June 30, 2001),

Related Package Code (In the PMS an associated package/rate code would be set up to designate this campaign and track its results.),

Cost of Conducting Campaign (Labor, Materials, Postage, etc.), and

Location of related Campaign Correspondence (Path of Merge Doc, PDF file or similar)

When this option is chosen, a form will appear where the details of the campaign are set up. Once the details are entered, the Campaign should be logged to a Campaign table and assigned a Campaign Number/Code. All related pieces of correspondence are tagged with this number/code.

A second option is to allow guest data to be analyzed and exported. (606) To accomplish this, the user performs the analytics process of FIG. 5. The user chooses the export format and specifies the location to which the data will be exported. (607) The data is then exported. (608) The process is exited. (609)

A third option permits the user to analyze data and incorporate the results into an existing campaign. (610) In a first step, the analyze data process is carried out and a selection of the campaign is made and additional data is incorporated. (611) Additional details may be recorded to the individual campaign table. (612) Lastly, the campaign is executed (e.g., send e-mails or print snail mail collateral). (613) The process is then complete at (614).

A fourth option allows campaign activity to be recorded. (615) To accomplish this, a user opens an input form (616) and inputs detailed campaign information. Input sources may be defined for automatic updating of campaign responses. (617) This new information is then added to the existing individual campaign tables. (619) The user is prompted t record additional campaigns (619) or else to exit. (620)

A fifth option allows campaign reports to be generated. (621) To accomplish this, a user selects the campaign on which a report is desired. (622) After selecting the desired campaign, the user may add additional parameters to the report if desired. (624, 625) The user can then preview, publish to a defined location or print the report. (626) Afterwards, additional reports may be generated (627) or else the process is concluded. (628)

The GRMS also generates and selectively distributes service team reports either automatically at user-defined intervals or at a user's request. Service team reports utilize reservation and guest information, member profile information and service sequence information contained within the GRMS and extracted from the PMSs to organize and distribute relevant guest information to the appropriate service team within the hotel to enable the timely and accurate delivery of customized accommodations and personalized service to the guest in accordance with the guest's preferences, interests and history.

The GRMS enables customizable “Tier Services.” Hotels chains which offer frequent guest programs (e.g., Hilton HHonors, Starwood Preferred Guest) may activate CALO's Tier Services capability. Tier Services allows the hotels or hotel companies to define specific recognition, services, amenities or other offerings to be provided for members of the hotel chain's frequent guest program. The guest may or may not have a profile within the system, but would still be identified at each hotel for his/her tier standing. Tier Services information is distributed to the front line hotel staff consistent with the delivery process defined for guest preferences. For example, Hilton may determine that all HHonors Diamond members are to receive five services and amenities (free upgrades to a suite, free local phone calls, an amenity, free access to the fitness center, and a food and beverage coupon) at any Hilton hotel. The application will identify the HHonors member and his or her tier (for example, Diamond, Gold, Silver) and distribute service team reports to enable the hotel to deliver the tier services and amenities.

The GRMS allows both default and custom reports to be generated. To protect guest privacy, service team reports limit the information provided to specific service teams to information that is both relevant and appropriate to that team.

Each GRMS user may determine the manner in which service team reports will be created and distributed. Service team reports will be created by the GRMS and accessible through any device connected to the GRMS. Service team reports can be forwarded to specific service teams at specific times through variety of distribution methods, including:

1) printing to specific printers;

2) electronic mailing to specific persons;

3) interfacing with a local task management system; and/or

4) forwarding information to specific employees via wireless devices.

The GRMS can automate the reporting which enables the delivery of a specific service sequence to support each guest's preferences. Default service sequences are defined for each recorded member preference to define the timing of the service delivery, the responsible team and the action to be taken. The GRMS enables site-specific customization of service sequences.

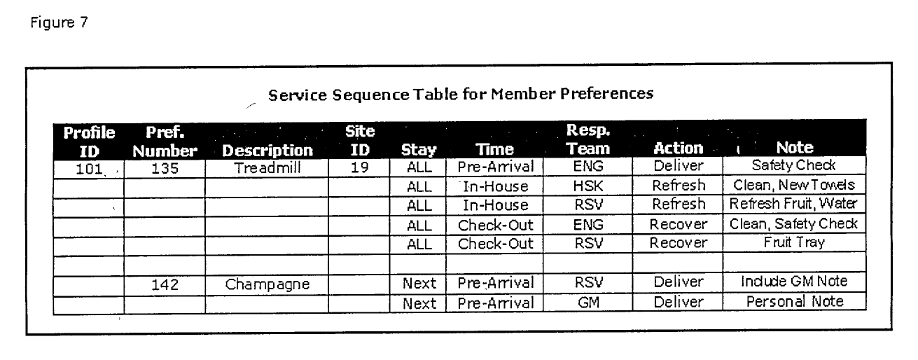

For example, in FIG. 7, Member #101 has recorded Preference #135, a treadmill. The default Service Sequence has been modified by site #19 to define the following sequence: Before the guest arrives, the engineering service team will be notified to deliver a treadmill to the guest's assigned room following a safety check of the equipment. Each day the guest is in the hotel, the housekeeping service team will be notified to clean the treadmill and provide new hand towels. Each day the guest is in the hotel, the Room Service team will be notified to deliver a tray of fresh fruit and bottled water. Upon check-out, the engineering service team will be notified to recover the treadmill, clean it and perform a safety check. Upon check-out, the Room Service team will be notified to recover the fruit tray.

The above example further demonstrates of the capability to define preference delivery times (both at the hotel level and at the corporate level) by specific guest stays. The example above notes that Member #101 will be rewarded with a bottle of champagne and a note from the hotel's general manager on her next stay. The system provides the opportunity to define specific stays including “next stay,” “next n stays,” “after n stays” and “next stay at property x.” This unique capability enables specific hotels and the chain to trigger the delivery of specific services automatically and consistently at specifically defined times.

The GRMS includes a Guest Communication System. The Guest Communication System is designed to manage the information exchange between the hotel and the guest to enhance the guest experience, reduce the likelihood of service errors and capitalize on marketing opportunities. The Guest Communication System creates customizable interaction capabilities during specific time periods of a guest lifecycle as follows:

Reservation

Confirmation email for reservations, reservation changes and cancellations

Personalized using guest profile data

Includes promotion that is mapped to guest preferences, interests, history

Requests addition or verification of frequent guest identification number

Pre-Arrival

Email introducing hotel products and services (spa reservations, dinner reservations)

up-selling

extended stay offers

local vendor promotions

maps, directions, schedule of events

request for submission of additional guest profile information (updated contact info, preferences, interests)

Check-In/Hotel Welcome

Personalized welcome letter in folio for profiled guests

Personalized welcome letters based on program definition for frequent guest members

Turndown Card with delivered preferences checked

Personalized hotel business cards

In-House

Interest update with in-house and local offers (paper, email, wireless devices)

Request for services (departure time, taxi required, car delivered)

Group communication (IBM sales meeting change of venue for scheduled lunch)

Check-Out

Email folio

Thank you note

Points total

Points required to reach next tier

Possible redemption offers with offer/reminder to make next reservation (link to reservations)

Promotional offers based on guest profile data

Post Visit

Thank you note

eComment Card, eSurvey

List of department emails for direct comment submission

Promotions based on guest profile (specific to property, brand chain)

The GRMS includes a Guest Recovery module. The Guest Recovery module is designed to perform the following functions:

a) import guest service records from the GPMS as well as local and corporate hotel systems,

b) record guest comments, complaints and negative experiences,

b) record current status of responses, actions taken and responsible individuals,

c) appends guest profiles with history of recovery activities.

Negative guest experiences are recorded in the Guest Recovery module. Each hotel may develop business rules and assign responsibilities for addressing each specific types of events. The Guest Recovery module tracks the status of the response, the actions taken and the responsible individuals to enable a timely and complete attempt at recovering the guest from a negative experience. A record of negative experiences and subsequent actions are associated with the specific guest profiles. Hotels will be aware, for example, that Mr. Jones submitted a guest comment card which noted that his room service order on Jan. 17, 2002 took 90 minutes to be delivered after being promised a 20 minute delivery. The GRMS enables guest profiles to be created, if one does not already exist, for any guest who endures a negative experience. The Guest Recovery module allows hotels to not only respond to negative experiences, but also to be aware of such past events for a future arrival by identifying returning guests who have had a negative experience recorded.

The GRMS includes a Task Management module. The Task Management module is integrated within the GRMS reporting system to assign tasks to specific individuals and organizations, record task status, and monitor delivery performance. The Task Management module accepts GRMS output and records the information distributed, the individual or team to which the information was mapped, and the time the information was distributed. The Task Management module accepts input from users to record completed events.

The GRMS also stores member interests within the member profile. The interest information is used at the chain level and at the hotel level to segment guests for marketing purposes. The interest information is also used at the individual hotel level to provide the appropriate service teams with additional information, which will enable them to offer services, both inside and outside the hotel, to match each member's interests.

The GRMS also permits individuals who have member profiles stored in the GRMS to have limited access to the GRMS to edit and update their own profiles. Members may contribute new information to the GRMS by submitting paper forms to the hotel, by making comments to hotel staff, or by interacting with the GRMS web site. Members may also review public and private information on the GRMS web site and export selected information to third-party applications. The following core modules enable interaction between the GRMS and members:

1) Update Profiles: Members have controlled access to their member profiles;

2) Forward Special Requests: Members may forward special requests to a specific hotel which may override or extend their existing set of preferences and interests for a defined upcoming stay;

3) Receive reservation confirmations by email: Members may receive reservations confirmations and also reminders of upcoming reservations.

4) Invite a Friend to Join: Members may invite others to participate in the profiling program with an automated electronic mailing system;

5) Review History: Members may review their own stay history and corresponding folio charges;

6) Download Folios: Members may import folio information for corporate expense reporting into corporate expense reporting software or for printed reports;

7) Member Marketing Communication: Members may receive newsletters, e-mail or other marketing programs tailored to the specific interests of individual members; Members may receive in advance an events schedule tailored to the interests of members over the specific period of their visits.

8) Member Comments: Members may submit online member comment cards, member satisfaction surveys and member complaints. The GRMS has the capability (via the Guest Recovery module) to record such information for immediate actions and future analysis;

9) Review Status of Requests: Members may use the website to get current status of requests. Requests include, for example, waitlist status, special service requests, accounting discrepancies, responses to comments, surveys and complaints; and

10) Member-Only Offers: Members may have access to offers designed specifically for participating members.

The GRMS allows authorized hotel staff to update the GRMS member profiles as follows:

1) The GRMS updates member profiles with new information resulting from member activity. Upon check-out, stay history and folio charges are recorded in each member's profile. The GRMS will also record all guest stay information and activity to support marketing initiatives.

2) The GRMS calculates stay information and adds or modifies preferences and prepares specific triggers in member profiles to support the delivery of defined services for members with specific stay volumes. For example, the GRMS may add a preference to a member profile after a defined number of stays to deliver a certain amenity for all future stays as a reward for past contributions and/or an upgrade in status.

3) Authorized hotel staff may add or update preferences, interests, and notes based on knowledge acquired by evaluating member activities. The GRMS may also accept input from complementary systems to automatically update member profiles. For example, the GRMS may interface with a task management system and convert requests to member preferences within a guest's profile.

The GRMS maintains a constant interface with each PMS of the participating hotels to automatically identify any change of status of a guest reservation (Scheduled Arrival, Cancelled, In-House, Checked-Out) and records each guest reservation upon check-out or cancellation. The chain can use the GRMS to analyze hotel-specific information as well as aggregate chain information. As noted above, the GRMS records member profiles with associated preferences, interests, notes and communication and stay history for specific guests. The GRMS allows for the efficient manipulation of this data for the following core activities:

1) Analysis and Reporting: the GRMS automatically generates pre-defined reports following the manipulation of reservation and member profile information. The GRMS also enables data manipulation for analysis and custom reporting resulting from Standard Query Language (SQL) manipulation of the databases;

2) Research & Development: the GRMS utilizes stored data from a data warehouse environment enabling access to multiple databases. The GRMS enables authorized, direct access to the data warehouse in conjunction with specific programming to evaluate historic results and trends as well as anticipate future results and trends. Hotels are able to better direct its investments in products and service enhancements and to improve specific areas of individual and enterprise hotel operations;

3) Marketing and Campaign Management: the GRMS enables authorized users to manipulate the data warehouse to initiate marketing campaigns targeted at specific Members. The GRMS delivers a full set of features to initiate, support, track, report and evaluate the performance of marketing campaigns.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for utilizing guest reservation data and stored guest information to identify and service specific guests at any of a plurality of geographically-dispersed hotels, said method comprising the steps of:
a. importing guest reservation information of a guest from at least one property management system (PMS) of at least one of a plurality of hotels into a central guest relationship management system (GRMS);
b. comparing said guest reservation information to at least one of existing reservations and guest information stored in said central guest relationship management system;
c. determining a status of said guest based on the comparison between said guest reservation information and at least one of said existing reservations and guest information;
d. using said status of said guest to deliver customized and personalized services according to recorded and projected preferences, interests or history.

2. The method of claim 1 which further comprises: soliciting guest information, based on user defined criteria, directly from targeted guests utilizing an automated system to generate solicitation letters and guest profiles pre-populated with reservation data extracted from the property management system.

3. The method of claim 1 which further comprises: determining if said guest reservation is related to any existing reservation or guest profile.

4. The method of claim 3 which further comprises: creating a new guest profile if said guest reservation is unrelated to any of the existing reservations or guest profiles wherein said status of said guest would be that of a new member.

5. The method of claim 3 which further comprises: appending said guest reservation and guest information to the existing member profile if said guest reservation and guest information are related to any of the existing guest profiles wherein said status of said guest would be that of an existing member.

6. The method of claim 3 which further comprises: determining the likelihood or probability that said guest reservation is related to a specific existing guest profile or guest reservation

7. The method of claim 1 wherein said status may be specific to a hotel, to a brand of hotels or to a chain consisting of multiple brands of affiliated hotels; said status may be determined by either hotel-specific definitions or by hotel brand or hotel chain definitions of status; said status may be identified as an attribute within a guest reservation or determined by the manipulation of stored guest data; said status is with respect to the number of hotel stays in a given time period, the number of room-nights recorded, the volume of spending recorded, and/or the specific attributes attached to a specific guest profile or guest reservation.

8. The method of claim 1 which further comprises: determining a value of said guest, said value is with respect to historical or projected contributions or specific attributes of said guest or of guest reservation.

9. The method of claim 1 which further comprises: monitoring and recording said guest activity utilizing data captured in hotel information systems and appending or modifying said guest profiles according to new activity and staff observations.

10. A method of recognizing profiled or specified guests at any of a plurality of hotels, wherein each hotel includes a device or system capable of exporting data from a property management system (PMS) and accessing a central guest relationship management system (GRMS), the method comprising the steps of:
a. at each of the plurality of hotel properties, assigning a unique guest identification number and corresponding guest profile to said specific guests and updating to the central GRMS the new and modified profiles;
b. matching the guest reservations at each hotel with the guest profiles stored in the central GRMS;
c. assembling profile information within the GRMS for guests whose reservations were determined to be a match with an existing guest profile or one or more specified attributes.

11. A method according to claim 1, further comprising the step of maintaining a dialogue or communications with the guest throughout the lifecycle of the guest's stay experience utilizing profile and reservation attributes to personalize the communication and customize offerings to the guest.

12. A method according to claim 1, further comprising the step of generating output from the GRMS determined by the reservation data from the property management system and guest information stored in the central GRMS, said method comprising the steps of:
a. analyzing said guest reservation, guest profile data, and a standard or custom-defined service delivery sequence matrix associated with each guest preference to determine the products or services to be delivered, the timing of the delivery, the sequencing of delivery events, and the responsible party or parties to support the product or service deliveries to accommodate the defined or projected preferences of the specific guests;
b. distributing output information and reports to specific individuals or service teams through the generation of paper reports or the electronic distribution of data to specific computer terminals or electronic devices, or through the distribution of information through a complementary support system such as a task management system;
c. accepting user-defined requests for manipulated guest profile and reservation data and collective GRMS data to generate the resultant reports;
d. producing pre-defined standard or custom reports automatically from pre-defined times or event-triggering activities.

13. A method, according to claim 1, wherein a computer and network architecture enable central storage of data, web-based access by the plurality of geographically dispersed hotels to the hosted GRMS application, and network-wide sharing of comprehensive guest profile data.

14. A method according to claim 1, wherein said guest reservation and guest information are determined related to the existing guest profile if at least one unique identifier and the abbreviated guest name are identical; the new reservation and guest information are determined to be a potential match if one of the unique identifiers or the abbreviated member name in the guest reservation and guest information matches a unique identifier or abbreviated guest name in the existing guest profile; and the information is determined not a match if neither the abbreviated guest name nor any of the unique identifiers match.

15. A method according to claim 10, wherein potential matches are presented to a user to allow the user to determine if the guest reservation and guest information are a match or are not a match.

16. A method according to claim 10, wherein a user can select criteria to allow the central GRMS to determine if the potential matches are actual matches or are not matches.

17. A method according to claim 11, wherein a user can define the output to be specific to each geographically dispersed hotel.

18. A method according to claim 11, wherein a user can define the service delivery sequence and responsibilities to be a default output or a custom output for each guest preference.

19. A method according to claim 1, wherein the guest reservation and guest information stored in the central GRMS can be accessed, viewed and/or edited by authorized individuals at each geographically dispersed hotel.

20. A method according to claim 1, wherein the stored guest profile data may be accessed and updated by complementary applications such as direct marketing applications or advanced analytics applications.

21. A method according to claim 1, wherein the guest is given access to the central GRMS to edit their own guest profile and communication options.

22. A method according to claim 1, wherein the guest reservation or guest information is entered into the central GRMS through a means for data transfer.

23. A method according to claim 1, wherein said method may be performed by entering the guest reservation and guest information into the central GRMS.

24. A method according to claim 1, wherein said guest comprises more than one guest or a particular group of guests.

25. A system for managing and utilizing guest data, comprising: a property management component configured to store the guest data from at least one of a plurality of geographically-dispersed hotels or restaurants; and a web-based guest management relationship component that imports and stores the guest data from said property management component in a database and a processing component that determines a guest status, and thereby delivers a service to a guest based on the guest data or the guest status.

26. A computer-readable medium for storing instructions on managing and utilizing guest data at any of a plurality of geographically-dispersed hotels or restaurants, said instructions comprising:
a. importing guest reservation information of a guest from at least one property management system (PMS) of at least one of a plurality of hotels into a central guest relationship management system (GRMS);
b. comparing said guest reservation information to at least one of existing reservations and guest information stored in said central guest relationship management system;
c. determining a status of said guest based on the comparison between said guest reservation information and at least one of said existing reservations and guest information;
d. using said status of said guest to deliver customized and personalized services according to recorded and projected preferences, interests or history.
